(19) United States
(12) Patent Application Publication
(10) Pub. No.: US 2010/0017648 A1
(43) Pub. Date: Jan. 21, 2010

(54) COMPLETE DUAL SYSTEM AND SYSTEM CONTROL METHOD

(75) Inventors: Yoshiaki Teruta, Kawasaki (JP); Teruyuki Goto, Kawasaki (JP); Kazuhiro Taniguchi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/565,207

(22) Filed: Sep. 23, 2009

Related U.S. Application Data
(63) Continuation of application No. PCT/JP2007/057853, filed on Apr. 9, 2007.

(51) Int. Cl. G06F 11/20; G06F 17/30

(52) U.S. Cl. 714/4; 714/16; 707/202; 707/E17.005; 714/E11.091

(57) ABSTRACT

A DB server included in an old operation node corrects a recovery log stored in a recovery log storage unit by using a difference log stored in a difference log storage unit. A duplication control device and a DBMS compare a difference log file stored in the difference log storage unit and a recovery log file stored in the recovery log storage unit, and correct the content of the recovery log file accordingly.

### CROSS-REFERENCE TO RELATED APPLICATION(S)

This application is a continuation of PCT international application Ser. No. PCT/JP2007/057853 filed on Apr. 9, 2007 which designates the United States, the entire contents of which are incorporated herein by reference.

### FIELD

The embodiments discussed herein are directed to a complete dual system in which a standby node is switched over to a new operation node when a trouble occurs in an operation node, and to a system control method therefor.

### BACKGROUND

Typically, organizations such as a business enterprise employ a complete dual system that does not have a common part such as a storage to maintain absolutely stable operation of a database (see, for example, Japanese Laid-open Patent Publication No. 2001-318801). In such a complete dual system, an operation node and a standby node do not share a common part such as a storage. Therefore, even if a trouble occurs in any device in the operation node, the operation node can be switched over to a standby node, thus, the system can be reconstructed.

In the complete dual system, however, the operation node and the standby node do not share a device such as a storage. Therefore, databases that are included in the operation node and the standby node are held therein so that the databases are consistent with each node.

The problem with the conventional complete dual system is that a downtime of an on-line operation when the system is reconstructed may take long.

That is, when the complete dual system is reconstructed by integrating thereinto, as a new standby node, an old operating node that is temporarily separated from the system due to occurrence of a trouble, the database in the new standby node and the database in the new operation node may not be consistent to each other. Therefore, in advance, all the data stored in a disk of the new operation node is copied to a disk of the old operation node that is integrated into the system as the new standby node. As a result, it is problematic in that a downtime of an on-line operation may take long in proportion to the size of the data thus copied.

When the system is thus reconstructed, a save area into which all the data stored in the new operation node is copied may be required to be provided in the disk of the old operation node that is integrated into the system as the standby node, and transferring cost is also required to be considered.

### SUMMARY

According to an aspect of the invention, a complete dual system includes an operation node that executes an on-line operation in response to a request from a user; a standby node that recovers the operation node when a trouble occurs in the operation node so that the on-line operation is restarted after the standby node is switched over to a new operation node; a modification history storage unit in which history of modifications made to a database included in the old operation node before the on-line operation is restarted is stored; a modification history correcting information storage unit in which modification history correcting information that is used to correct the history of the modifications stored in the modification history storage unit to be equivalent to a state when the on-line operation is restarted is stored; a modification history correcting unit that corrects the history of the modifications stored in the modification history storage unit to be equivalent to the state when the on-line operation is restarted by using the modification history correcting information stored in the modification history correcting information storage unit; and a database recovering unit that recovers the database included in the old operation node to be equivalent to the state when the on-line operation is restarted, based on the history of the modifications corrected by the modification history correcting unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic illustrating an overview and features of a complete dual system according to a first embodiment of the present invention;

FIG. 2 is another schematic illustrating an overview and features of the complete dual system according to the first embodiment;

FIG. 3 is still another schematic illustrating an overview and features of the complete dual system according to the first embodiment;

FIG. 4 is still another schematic illustrating an overview and features of the complete dual system according to the first embodiment;

FIG. 5 is still another schematic illustrating an overview and features of the complete dual system according to the first embodiment;

FIG. 6 is still another schematic illustrating an overview and features of the complete dual system according to the first embodiment;

FIG. 7 is a block diagram of the configuration of each node according to the first embodiment;

FIG. 8 is a schematic of an example of correction of a recovery log file according to the first embodiment;

FIG. 9 is another schematic of an example of correction of a recovery log file according to the first embodiment;

FIG. 10 is a flowchart of a difference log file reading process according to the first embodiment;

FIG. 11 is a flowchart of a recovery log file reading process according to the first embodiment;

FIG. 12 is flowchart of a recovery log file correcting process according to the first embodiment;

FIG. 13 is a flowchart of a system reconstructing process according to the first embodiment; and

FIG. 14 is a block diagram of a computer that executes a system control program.

### DESCRIPTION OF EMBODIMENTS

Preferred embodiments of the present invention will be explained with reference to accompanying drawings. A complete dual system according to the present invention is first described as a first embodiment of the present invention, and then, another embodiment thereof is described.

### [a] First Embodiment

An overview and features of a complete dual system according to the first embodiment are described. Then, the configuration of each node that constitutes the complete dual system and processes performed thereby are described, followed by an effect of the first embodiment.

Overview and Features of Complete Dual System

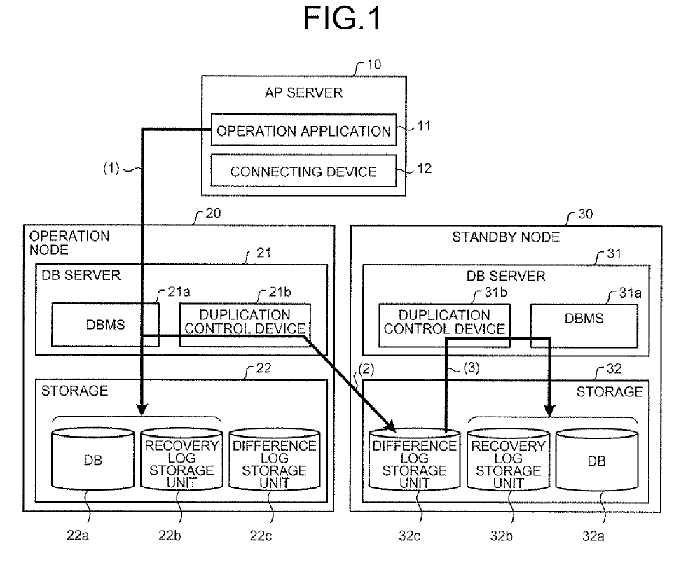

First, an overview and features of the complete dual system according to the first embodiment are described with reference to FIGS. 1 to 6. FIGS. 1 to 6 are schematics illustrating an overview and features of the complete dual system according to the first embodiment.

The complete dual system according to the first embodiment includes an operation node that executes an on-line operation in response to a request from a user and a standby node that recovers the operation node. When a trouble occurs in the operation node, the standby node is switched over to a new operation node, and then, the on-line operation is restarted. A main feature of the complete dual system according to the present invention is that a downtime of an on-line operation can be reduced to be zero when the complete dual system is reconstructed by integrating thereinto, as a new standby node, an old operation node that is temporarily separated from the system due to occurrence of a trouble.

Processes performed by the complete dual system according to the first embodiment in normal operation are described. As depicted in FIG. 1, the complete dual system according to the first embodiment is duplexed by an operation node 20 that executes a process related to an on-line operation in response to a request from an application (AP) server 10 and a standby node 30 that recovers the operation node 20, and communicably connected to the AP server 10 via a network or the like.

The AP server 10 includes an operation application 11 that can perform an on-line operation and a connecting device 12. Upon receiving an operation performed by a user, the AP server 10 notifies the operation node 20 of a request related to an on-line operation according to the operation (for example, a request to perform a transaction that is a unit of a series of processes) via the connecting device 12.

The operation node 20 includes a database (DB) server 21 and a storage 22. The DB server 21 includes a database management system (DBMS) 21a that manages and controls access and the like to the storage 22 and a duplication control device 21b that makes the databases stored in the nodes (the operation node 20 and the standby node 30) consistent to each other (guarantee the equivalency).

The storage 22 includes a DB 22a, a recovery log storage unit 22b, and a difference log storage unit 22c. In the DB 22a, processing data related to on-line operations are stored. In the recovery log storage unit 22b, history of processes related to on-line operations in response to requests from a user (for example, information such as instructions from a user and modifications committed to the database, for each transaction. Hereinafter, “recovery log”) is stored in the form of a file. In the difference log storage unit 22c, logs that are used to update the DB 22a with the updates made to a DB 32a after the on-line operation is restarted by using the standby node 30 due to occurrence of a trouble in the operation node 20 (hereinafter, “difference log”) are stored in the form of files.

Similarly to the difference log storage unit 22c, generally, a difference log storage unit 32c included in a storage 32 is used to update the DB 32a with the updates made to the DB 22a. The difference log storage unit 32c is also used to correct the recovery logs stored in the recovery log storage unit 22b when the operation node 20 in which a trouble has occurred is integrated into the complete dual system as a new standby node. Each difference log includes information that guarantees the consistency (equivalency) of the databases that are stored in the nodes and information that is used to recover the database stored in the storage in which the difference log is stored.

The standby node 30 has a similar configuration to the operation node 20, and includes a DB server 31 and the storage 32. The DB server 31 has a similar configuration to the DB server 21, and includes a DBMS 31a and a duplication control device 31b. The storage 32 has a similar configuration to the storage 22 and includes the DB 32a, a recovery log storage unit 32b, and a difference log storage unit 32c.

In the configuration above, in normal operation, the DB server 21 in the operation node 20 executes a process related to an on-line operation in response to a request from a user, notified by the AP server 10, obtains a log related to the process, and stores the log in the recovery log storage unit 22b as a recovery log (see (1) in FIG. 1). The DB server 21 stores the log thus obtained in the difference log storage unit 32c included in the standby node 30 as a difference log, via the duplication control device 21b (see (2) in FIG. 1). The DB server 31 included in the standby node 30 requests the DBMS 31a to update the DB 32a with the contents of the difference logs stored in the difference log storage unit 32c. Consequently, the DBMS 31a and the duplication control device 31b update the recovery logs that are stored in the recovery log storage unit 32b with the contents of the difference logs, and the DBMS 31a updates the DB 32a based on the recovery logs that are stored in the recovery log storage unit 32b (see (3) in FIG. 1).

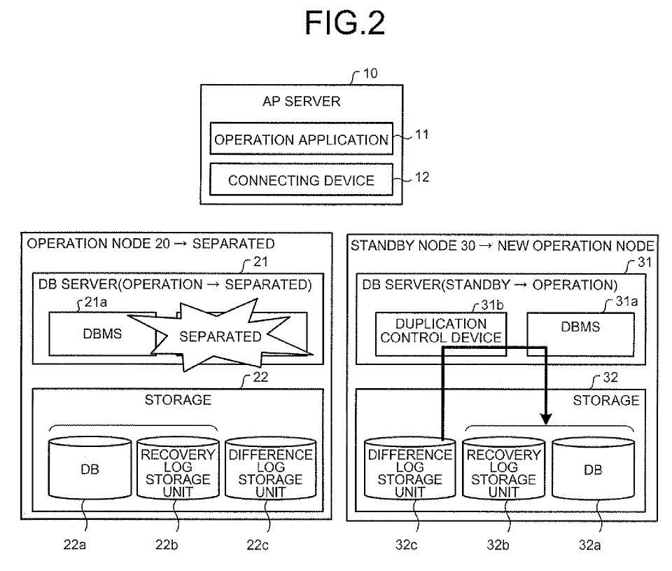

Operation condition of the operation node when a trouble occurs therein is described below. As depicted in FIG. 2, when a trouble occurs in the operation node 20, the operation node 20 is separated from the system, and the standby node 30 is switched over to a new operation node. Then, the DB server 31 included in the standby node 30 requests the DBMS 31a to update the contents of the committed difference logs (the logs in which a transaction is determined to be performed) stored in the difference log storage unit 32c. Consequently, the DBMS 31a and the duplication control device 31b update the recovery logs that are stored in the recovery log storage unit 32b with the contents of the difference logs, and the DBMS 31a updates the DB 32a based on the recovery logs that are stored in the recovery log storage unit 32b.

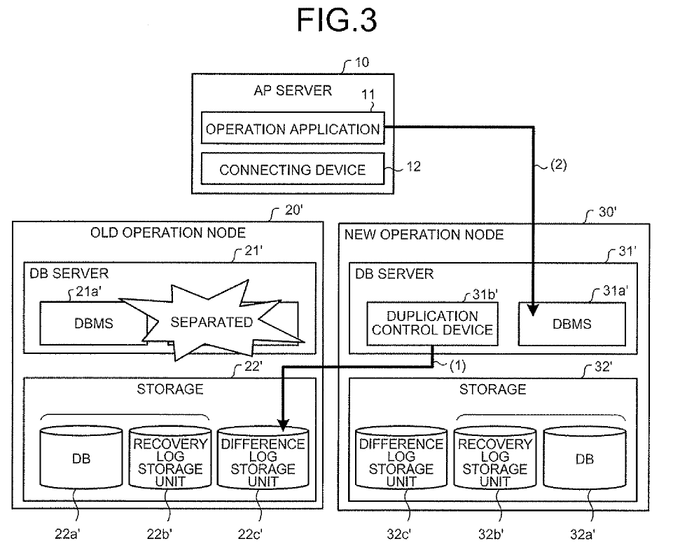

As depicted in FIG. 3, when a DB server 31′ included in a new operation node 30′ takes over a process related to an on-line operation in response to a request from the user notified by the AP server 10, after the DB server 31′ has obtained a log related to the process, the DB server 31′ prepares to store the log as a difference log in a difference log storage unit 22c′ included in a storage 22′ of an old operation node 20′ (see (1) in FIG. 3). Then, the DB server 31′ included in the new operation node 30′ restarts the process related to the on-line operation (see (2) in FIG. 3).

The complete dual system according to the first embodiment thus performs a process in normal operation and in operation in which a trouble occurs therein. A main feature of the complete dual system is a process when the complete dual system is reconstructed by integrating the old operation node 20′ as a new standby node, as described below.

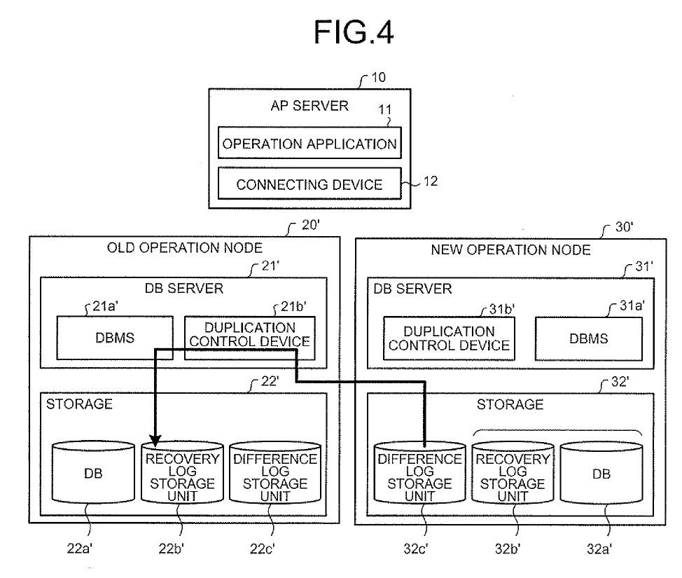

As depicted in FIG. 4, a DB server 21′ included in the old operation node 20′ corrects the recovery logs stored in a recovery log storage unit 22b′ by using the difference logs stored in the difference log storage unit 32c′. More specifically, a duplication control device 21b′ and a DBMS 21a′ compare the final serial number of the difference log files stored in the difference log storage unit 32c′ (hereinafter, “final difference log serial number”) with the final serial number of the recovery log file stored in the recovery log storage unit 22b′ (hereinafter, “final recovery log serial number”), and then, corrects the content of the recovery log file according to the result of the comparison.

The correction thus performed is described below in detail. The duplication control device 21b′ and the DBMS 21a′ compare the final difference log serial number with the final recovery log serial number, as a result, if the final difference log serial number is larger than the final recovery log serial number, the duplication control device 21b′ and the DBMS 21a′ correct the content of the recovery log file by complementing the recovery log file with the contents of the logs that are not stored in the recovery log file from the difference log files. On the other hand, if the final recovery log serial number is larger than the final difference log serial number as a result of comparing the final difference log serial number with the final recovery log serial number, the logs that are newer than the final difference log serial number are nullified in the recovery logs stored in the recovery log file (the recovery logs are deleted from the recovery log file). If the final difference log serial number and the final recovery log serial number match with each other, correction is not performed.

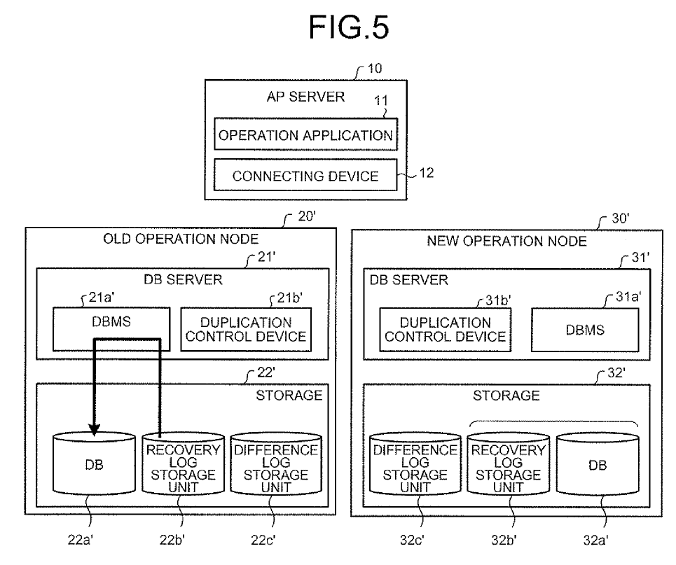

The duplication control device 21b′ and the DBMS 21a′ correct the content of the recovery log file, and then, the DBMS 21a′ included in the old operation node 20′ updates a DB 22a′ based on the corrected recovery logs stored in the recovery log storage unit 22b′, as depicted in FIG. 5. Thus, when the on-line operation is restarted by switching over the standby node 30 into the new operation node 30′ due to occurrence of a trouble, the DB 22a′ included in the old operation node 22′ can be recovered to be equivalent to a DB 32a′ of the new operation node 30′, even though the contents of the DB 22a′ and the DB 32a′ may be inconsistent to each other at the timing of switching over.

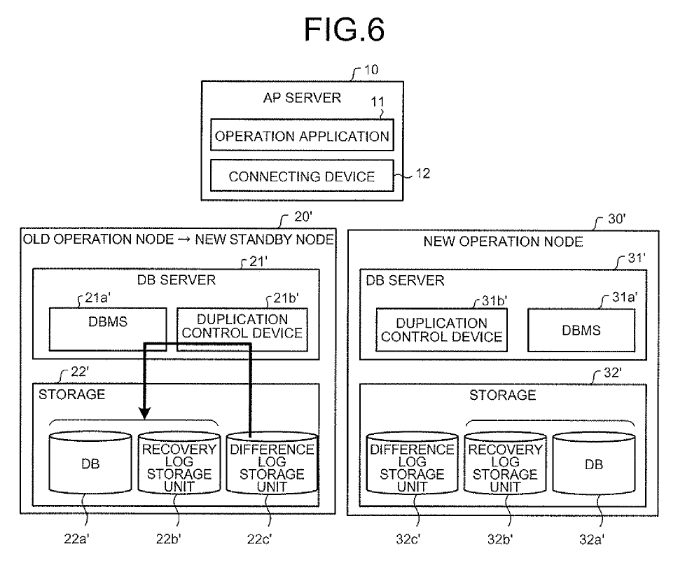

The complete dual system according to the first embodiment integrates the old operation node 20′ as a new standby node, and reconstructs the system. As depicted in FIG. 6, the DB server 21′ requests the DBMS 21a′ to update the contents of the difference logs (the processes such as new DB modifications due to restarting the on-line operation) stored in the difference log storage unit 22c′ before the system is reconstructed after the on-line operation is restarted by using the new operation node 30′. Consequently, the DBMS 21a′ and the duplication control device 21b′ update the recovery logs that are stored in the recovery log storage unit 22b′ with the content of the difference log, and the DBMS 21a′ starts updating the DB 22a′ based on the recovery logs that are stored in the recovery log storage unit 22b′ that is updated with the content of the difference log. That is, the DB 32a′ included in the new operation node 30′ and the DB 22a′ included in the old operation node 20′ are made to be consistent to each other (guarantee the equivalency), and then, the system is reconstructed.

Thus, in the complete dual system according to the first embodiment, when the system is reconstructed by integrating into the system, as a new standby node, an old operation node that is temporarily separated from the system due to occurrence of a trouble, a downtime of an on-line operation can be reduced to be zero.

Configuration of Nodes

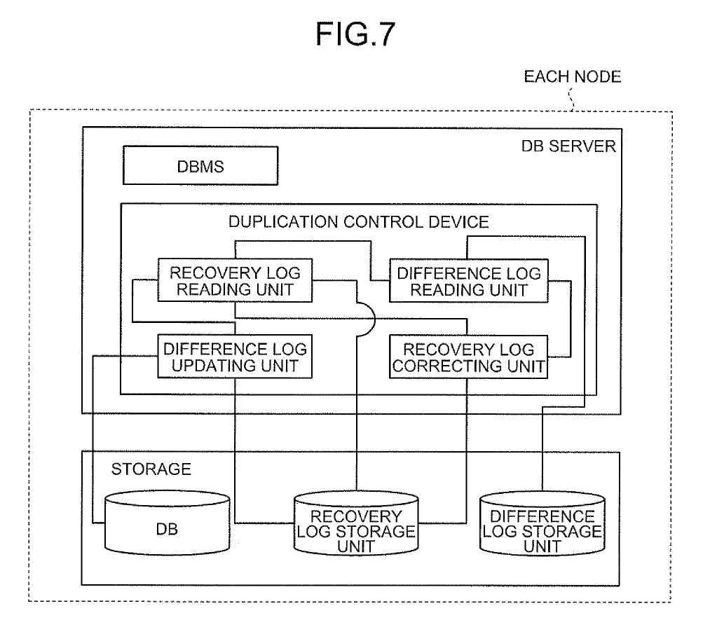

Configuration of each node that constitutes the complete dual system according to the first embodiment is described below with reference to FIG. 7. FIG. 7 is a block diagram of the configuration of each node according to the first embodiment. In FIG. 7, only components that are closely related to describe each node according to the first embodiment are illustrated, and the other components are omitted.

As depicted in FIG. 7, each of the nodes (an operation node and a standby node) according to the first embodiment includes a DB server and a storage.

The storage stores therein data and computer programs that are related to an on-line operation. Components of the storage that are closely related to the present invention are, for example, a DB in which processing data related to an on-line operation, a recovery log storage unit in which history of processes related to an on-line operation in response to a request from a user (hereinafter, “recovery log”) is stored in the form of a file, a difference log storage unit in which a log that is used to correct the recovery logs stored in the recovery log storage unit (hereinafter, “difference log”) in the form of a file.

The DB server has an internal memory in which programs such as a predetermined control program, a computer program in which various processing procedures and the like are prescribed, and required data are stored therein, and executes various processes by using such programs and data. The DB server has, as components closely related to the present invention, a DBMS that manages and controls access and the like to the storage and a duplication control device that is used to make the databases stored in the nodes (the operation node and the standby node) consistent to each other (guarantee the equivalency).

The duplication control device has, as the components closely related to the present invention, a difference log reading unit, a recovery log reading unit, a recovery log correcting unit, and a difference log updating unit. Below, a correcting process of recovery logs required for integrating a old operation node into the system as a new standby node is mainly described.

The difference log reading unit included in the old operation node sequentially reads the difference log files, one by one, stored in the difference log storage unit included in the new operation node, up to the final difference log file. The difference log reading unit sets the difference log serial number assigned to the final difference log file to be the final difference log serial number, and notifies the recovery log correcting unit included in the old operation node of the final difference log serial number. The difference log reading unit included in the old operation node receives the final recovery log serial number from the recovery log reading unit included in the old operation node, sequentially reads the difference log files, one by one, having a serial number larger than the final recovery log serial number, up to the file difference log file.

The recovery log reading unit included in the old operation node sequentially reads the recovery log file, one by one, that are stored in the recovery log storage unit included in the old operation node up to the final recovery log file. The recovery log reading unit sets the recovery log serial number assigned to the final recovery log file to be the final recovery log serial number, and notifies the difference log reading unit and the recovery log correcting unit included in the old operation node of the final recovery log serial number.

The recovery log correcting unit and the DBMS that are included in the old operation node correct the recovery logs stored the recovery log storage unit included in the old operation node, by using the final difference log serial number received from the difference log reading unit included in the old operation node and the final recovery log serial number received from the recovery log reading unit included in the old operation node.

More specifically, the recovery log correcting unit and the DBMS included in the old operation node receive the final difference log serial number and the final recovery log serial number respectively, and then, compare the final difference log serial number and the final recovery log serial number with each other to verify whether the final difference log serial number is larger than the final recovery log serial number.

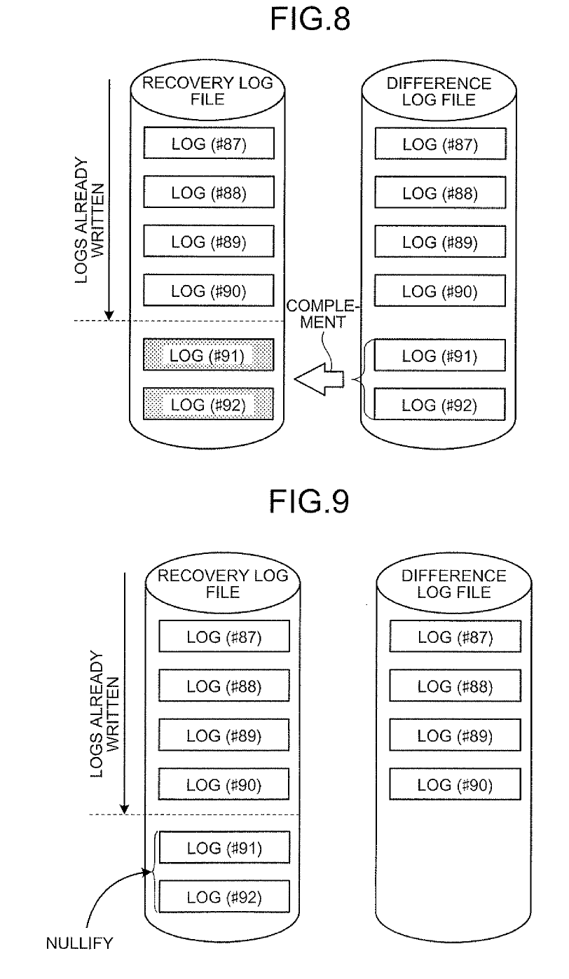

If the final difference log serial number is larger than the final recovery log serial number as a result of the verification, the recovery log correcting unit and the DBMS included in the old operation node sequentially read the difference log files, one by one, having a serial number larger than the final recovery log serial number. Then, the recovery log correcting unit and the DBMS that are included in the old operation node complement the recovery log file with the different log files thus read, thereby correcting the content of the recovery log file (see FIG. 8).

The recovery log correcting unit and the DBMS included in the old operation node determine whether the difference log serial number of the difference log file presently read is equal to the final difference log serial number. If the difference log serial number is equal to the final difference log serial number as a result of the determination, the recovery log correcting unit and the DBMS included in the old operation node terminate the recovery log file correcting process. On the other hand, if the difference log serial number of the difference log presently read is not equal to the final difference log serial number, the recovery log correcting unit and the DBMS included in the old operation node read a different log file next in line.

The recovery log correcting unit and the DBMS included in the old operation node compare the final difference log serial number and the final recovery log serial number with each other, verify whether the final recovery log serial number is larger than the final difference log serial number. If the final recovery log serial number is larger than the final difference log serial number as a result of the verification, the recovery log correcting unit and the DBMS included in the old operation node nullify (delete from the recovery log file, see FIG. 9) the recovery logs stored in the recovery log file that are newer than the final difference log serial number. On the other hand, if the final recovery log serial number is not larger than the final difference log serial number as a result of the verification (that is, the final difference log serial number and the final recovery log serial number are equal to each other), the recovery log correcting unit and the DBMS included in the old operation node terminate the recovery log file correcting process.

After the contents of the recovery log files are corrected by the recovery log correcting unit and the DBMS included in the old operation node, the DBMS included in the old operation node updates the DB included in the old operation node according to the recovery logs thus corrected stored in the recovery log storage unit included in the old operation node (see FIG. 5). Thus, when the on-line operation is restarted by switching over the standby node to the new operation node due to occurrence of a trouble, the contents of the DBs may be inconsistent to each other at the timing of the switching over. Even then, the DB included in the old operation node can be recovered to be equivalent to the DB included in the new operation node.

The difference log updating unit and the DBMS included in the old operation node receive an updating request from the DB server, and then, updates the recovery logs stored in the recovery log storage unit with the contents of the difference logs stored in the difference log storage unit (that is, the processes such as new DB modifications due to restarting the on-line operation) before the system is reconstructed after the on-line operation is restarted by using the new operation node. The DBMS included in the old operation node starts updating the DB included in the old operation node according to the recovery logs thus updated with the contents of the difference logs. Thus, the DB included in the old operation node is updated with processes such as DB modification in the new operation node due to restarting of the on-line operation. The databases included in the new operation node and the new standby node are made to be consistent to each other (guarantee the equivalency), and then, the system is reconstructed.

Thus, reconstruction of the system is completed by integrating into the system, as a new standby node, the old operation node including a DB that is made to be consistent to a DB included in the new operation node.

Processes performed by the difference log reading unit, the recovery log reading unit, the recovery log correcting unit, and the recovery log updating unit are performed asynchronously so that the processes can be performed efficiently.

Processes Performed by Nodes

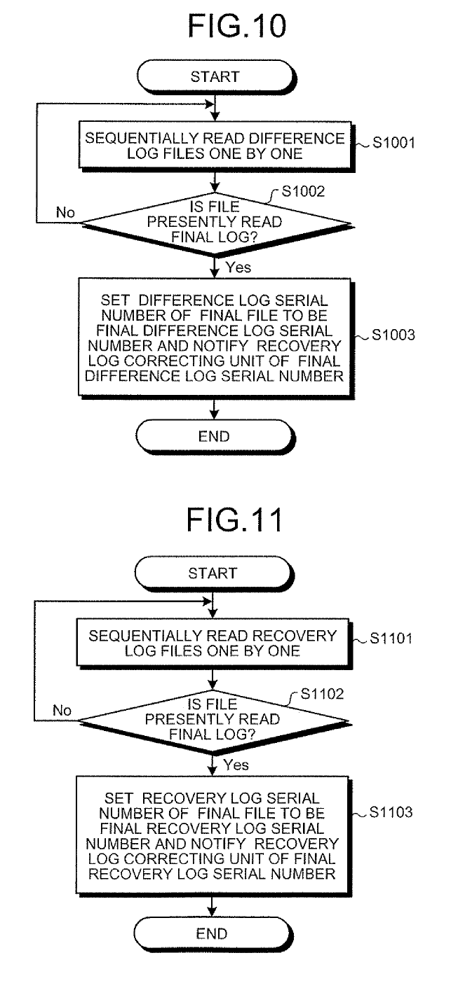

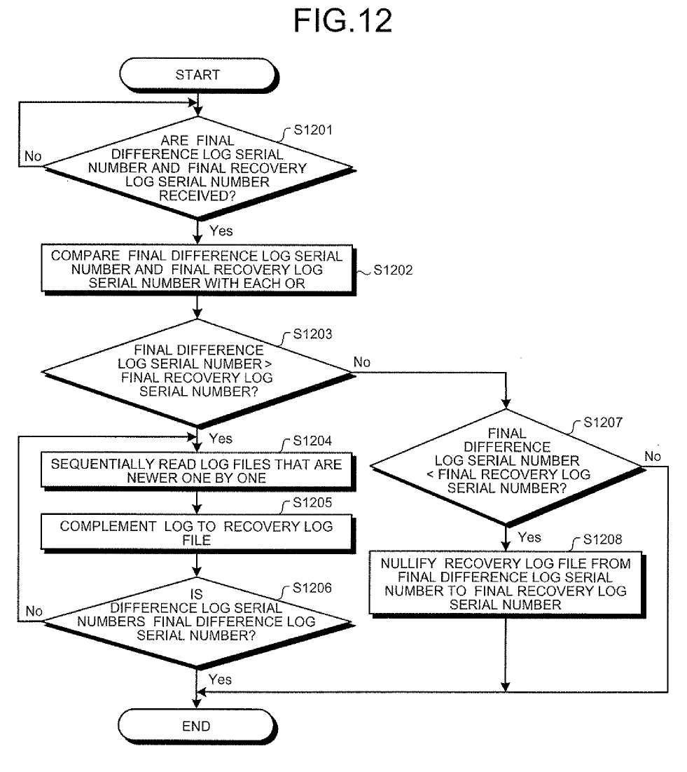

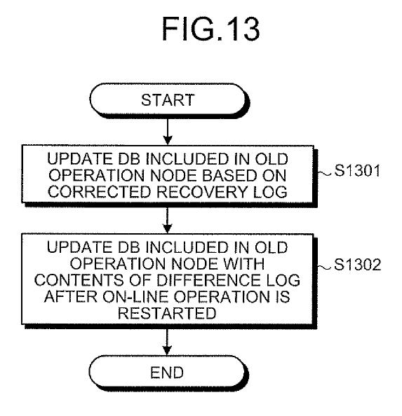

Processes performed by the nodes according to the first embodiment are described below with reference to FIGS. 10 to 14. FIG. 10 is a flowchart of the difference log file reading process according to the first embodiment. FIG. 11 is a flowchart of the recovery log file reading process according to the first embodiment. FIG. 12 is a flowchart of the recovery log file correcting process according to the first embodiment. FIG. 13 is a flowchart of the system reconstructing process according to the first embodiment.

Log File Reading Process

The log file reading process according to the first embodiment is described blow with reference to FIG. 10.

As depicted in FIG. 10, the difference log reading unit included in the old operation node sequentially reads the difference log files, one by one, stored in the difference log storage unit included in the new operation node (Step S1001), and verifies whether the file presently read is the final difference log file (Step S1002). If the file thus read is the final difference log as a result of the verification (YES at Step S1002), the difference log reading unit included in the old operation node sets the difference log serial number assigned to the final difference log file to be the final difference log serial number, and notifies the recovery log correcting unit included in the old operation node of the final difference log serial number (Step S1003). On the other hand, if the file thus read is not the final difference log file (NO at Step S1002), the difference log reading unit included in the old operation node reads a difference log next in line from the difference log storage unit.

Recovery Log File Reading Process

The recovery log file reading process according to the first embodiment is described below with reference to FIG. 11.

As depicted in FIG. 11, the recovery log reading unit included in the old operation node sequentially reads the recovery log files, one by one, stored in the recovery log storage unit (Step S1101), and verifies whether the file presently read is the final recovery log file (Step S1102). If the file presently read is the final recovery log file as a result of the verification (YES at Step S1102), the recovery log reading unit included in the old operation node sets the recovery log serial number assigned to the final recovery log file to be the final recovery log serial number, and notifies the recovery log correcting unit included in the old operation node of the final recovery log serial number (Step S1103). On the other hand, if the file presently read is not the final recovery log file (NO at Step S1102), the recovery log reading unit included in the old operation node reads a recovery log file next in line from the recovery log storage unit.

Recovery Log File Correcting Process

The recovery log file correcting process according to the first embodiment is described below with reference to FIG. 12.

The recovery log correcting unit and the DBMS included in the old operation node correct the recovery log stored in the recovery log storage unit included in the old operation node by using the final difference log serial number received from the difference log reading unit included in the old operation node and the final recovery log serial number received from the recovery log reading unit included in the old operation node.

As depicted in FIG. 12, if each of the recovery log correcting unit and the DBMS included in the old operation node receives the final difference log serial number and the final recovery log serial number (YES at Step S1201) the recovery log correcting unit and the DBMS compare the final difference log serial number and the final recovery log serial number with each other (Step S1202), and verify whether the final difference log serial number is larger than the final recovery log serial number (Step S1203).

If the final difference log serial number is larger than the final recovery log serial number as a result of the verification (YES at Step S1203), the recovery log correcting unit and the DBMS included in the old operation node sequentially read the difference log files, one by one, having a serial number larger than the final recovery log serial number (Step S1204). Then, the recovery log correcting unit and the DBMS included in the old operation node complement the recovery log file with the difference log files presently ready (Step S1205), and thus correct the contents of the recovery log file (see FIG. 8).

The recovery log correcting unit and the DBMS included in the old operation node determine whether the difference log serial number of the difference log file presently read is the final difference log serial number (Step S1206). If the difference log serial number thereof is the final difference log serial number as the result of the determination (YES at Step S1206), the recovery log correcting unit and the DBMS included in the old operation node terminate the recovery log file correcting process. On the other hand, if the difference log serial number of the difference log file presently read is not the final difference log serial number (No at Step S1206), the recovery log correcting unit and the DBMS included in the old operation node read the a difference log file next in line.

Returning to the description of Step S1203, the recovery log correcting unit and the DBMS included in the old operation node compare the final difference log serial number and the final recovery log serial number with each other, and if the final difference log serial number is not larger than the final recovery log serial number (No at Step S1203), the recovery log correcting unit and the DBMS verify whether the final recovery log serial number is larger than the final difference log serial number (Step S1207). If the final recovery log serial number is larger than the final difference log serial number as a result of the verification (Yes at Step S1207), the recovery log correcting unit and the DBMS included in the old operation node nullify the recovery logs stored in the recovery log file newer than the final difference log serial number (delete from the recovery long file, see FIG. 9) (Step S1208). On the other hand, if the final recovery log serial number is not larger than the final difference log file as a result of the verification (that is, the final difference log serial number is equal to the final recovery log serial number) (NO at Step S1207), the recovery log correcting unit and the DBMS included in the old operation node terminate the recovery log file correcting process.

System Reconstructing Process

The system reconstructing process according to the first embodiment is described below with reference to FIG. 13.

As depicted in FIG. 13, the recovery log correcting unit and the DBMS included in the old operation node correct the contents of the recovery log files before the DBMS included in the old operation node updates the DB included in the old operation node according to the corrected recovery logs stored in the recovery log storage unit included in the old operation node (Step S1301). Thus, when an on-line operation is restarted by switching over the standby node to the new operation node due to occurrence of a trouble, the contents of the DBs 22a′ and 32a′ may be inconsistent to each other at the timing of the switching over. Even in such a case, the DB included in the old operation node can be recovered to be equivalent to the DB included in the new operation node.

The difference log updating unit and the DBMS included in the old operation node receive an updating request from the DB server, and updates the recovery logs stored in the recovery log storage unit with the contents of the difference logs stored in the difference log storage unit (that is, the processes such as new DB modifications due to restarting the on-line operation) before the system is reconstructed after the on-line operation is restarted by using the new operation node. The DBMS included in the old operation node starts updating the DB included in the old operation node according to the recovery logs thus updated with the contents of the difference logs. Thus, the DB included in the old operation node is updated with processes such as DB modification in the new operation node due to restarting the on-line operation (Step S1302). The databases included in the new operation node and the old operation node are made to be consistent to each other (guarantee the equivalency), and the system is reconstructed.

Thus, reconstruction of the system is completed by integrating into the system, as the new standby node, the old operation node including the DB that is made to be consistent to the DB included in the new operation node.

### Effects of First Embodiment

As described above, according to the first embodiment, the complete dual system stores therein a recovery log that is history of modification made to the database included in the old operation node before an on-line operation is restarted (for example, information related to the on-line operation in response to a request from a user, such as instructions from a user and committed modification made to the database, for each transaction is stored in the system); stores therein a difference log that is used to correct the stored recovery log so that the stored recovery log is equivalent to the recovery log at the timing of restarting the on-line operation; corrects the recovery log so that the recovery log is equivalent to the recovery log at the timing of restarting the on-line operation by using the difference log stored therein; and recovers the database included in the old operation node so that the database is equivalent to the database at the timing of restarting the on-line operation according to the corrected recovery log. Therefore, the database included in the old operation node can be made to be equivalent (that is, the data can be made to be consistent to each other) to the database included in the new operation node in an easy way so that the database is equivalent to the database at the timing of restarting the on-line operation by using the new operation node that takes over the on-line operation. The database can be made equivalent to the database at the timing of restarting the on-line operation in an easy way. As a result, when the system is reconstructed due to occurrence of a trouble in the operation node, a downtime of an on-line operation can be reduced to be zero.

According to the first embodiment, as a result of comparing the recovery log and the difference log that are stored in the storage, if the information stored in the recovery log is newer than the information stored in the difference log, the newer information is nullified, thereby correcting the recovery log. If the information stored in the difference log is newer than the recovery log, the newer information is complemented to the recovery log, thereby correcting the recovery log. Thus, the recovery log can be corrected in an easy way so that the recovery log is equivalent to the recovery log at the timing of restarting the on-line operation by referring to the difference log.

According to the first embodiment, when the system is reconstructed by integrating into the system, as a new standby node, the old operation node in which the database included is recovered to be equivalent to the database at the timing of restarting the on-line operation, the database included in the new standby node is updated with the modifications made to the database included in the new operation node before the system is reconstructed after the on-line operation is restarted. Therefore, without fail, the database included in the new operation node can be updated with the modifications made to the database included in the new operation node before the system is reconstructed after the on-line operation is restarted. As a result, the database can be assured to be redundant.

In the first embodiment, an example is described in which a difference log that is used to correct a recovery log is stored in the standby node. The present invention is, however, not limited thereto. A difference log may be stored in the operation node, transferred to the standby node, and then the difference log transferred to the standby node may be saved in the standby node.

In the first embodiment, when a committing process is performed in the operation node, writing of the recovery log or the difference log may be guaranteed, for example, by sending and receiving a confirmation notice that writing of the recovery log or the difference log is completed between the nodes or by referring to writing completion information. Difference transfer between the nodes may be performed in a synchronous mode or in an asynchronous mode.

### [b] Other Embodiment

The present invention may be implemented in various embodiments other than the first embodiment described above. Another embodiment of the present invention is described below.

(1) Apparatus Configuration and the Like

Respective configuration elements of the duplication control device depicted in FIG. 7 are functionally conceptual and are not always physically configured as illustrated. Specifically, a specific pattern into which the devices are dispersed or integrated is not limited to the illustrated pattern. The devices may be configured by functionally or physically dispersing or integrating all or some of the devices on any unit, for example, by integrating all or a part of the recovery log correcting unit and the difference log updating unit, in accordance with various loads or usages. All or some of the processing functions performed by the duplication control device may be implemented by a central processing unit (CPU) or a computer program that is analyzed and executed by the CPU, or by a wired-logic hardware.

(2) System Control Programs

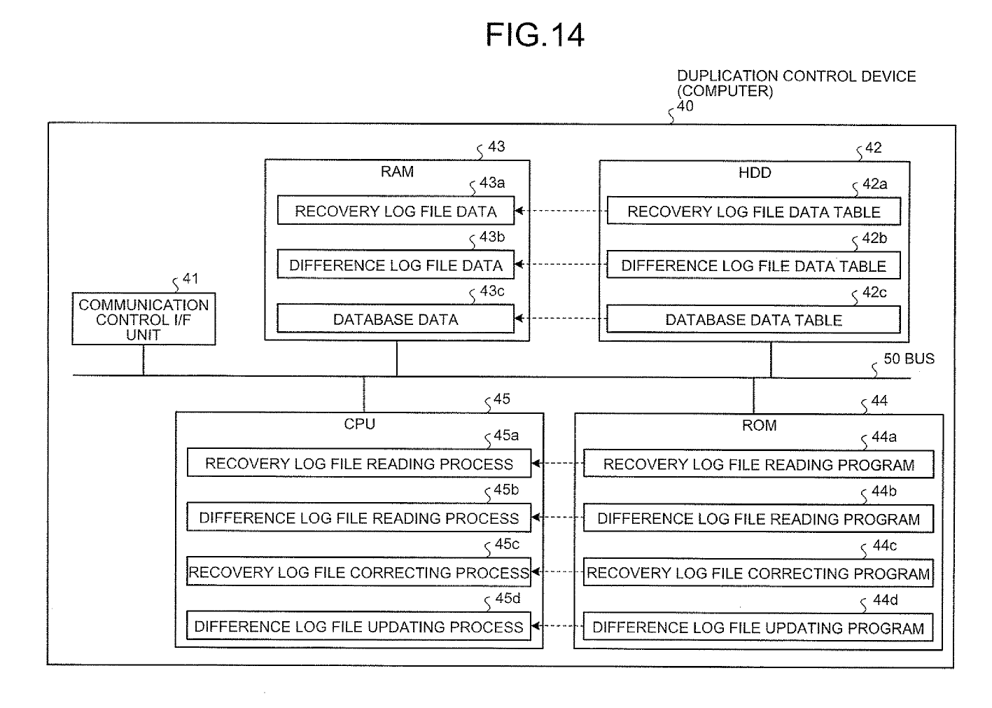

The various processes described above (for example, see FIGS. 13 and 14) may be realized by executing a computer program on a computer such as a personal computer and a workstation prepared in advance. An example of a computer that executes system control programs having the functions similar to the first embodiment will be explained with reference to FIG. 14. FIG. 14 is a block diagram of a computer that executes the system control programs.

As depicted in FIG. 14, a computer 40 that serves as the duplication control device includes a communication control I/F unit 41, a hard disk drive (HDD) 42, a random access memory (PAM) 43, a read only memory (ROM) 44, and a CPU 45 that are connected to each other via a bus 50.

The system control programs having the functions similar to the duplication control device in the first embodiment, that is, a recovery log file reading program 44a, a difference log file reading program 44b, a recovery log file correcting program 44c, and a difference log file updating program 44d are stored in the ROM 44 in advance as depicted in FIG. 14. The computer programs 44a, 44b, 44c, and 44d may be optionally dispersed or integrated, similarly to the respective configuration elements of the duplication control device depicted in FIG. 7. The ROM 44 may be a nonvolatile “RAM”.

The CPU 45 reads the computer programs 44a, 44b, 44c, and 44d from the ROM 44, and executes the computer programs. Thus, the computer programs 44a, 44b, 44c, and 44d respectively function as a recovery log file reading process 45a, a difference log file reading process 45b, a recovery log file correcting process 45c, and a difference log file updating process 45d as depicted in FIG. 14. The processes 45a, 45b, 45c, and 45d correspond respectively to the recovery log reading unit, the difference log reading unit, the recovery log correcting unit, and the difference log updating unit included in the duplication control device depicted in FIG. 7.

The HDD 42 includes a recovery log file data table 42a, a difference log file data table 42b, and a database data table 42c as depicted in FIG. 14. The recovery log file data table 42a, the difference log file data table 42b, and the database data table 42c correspond respectively to the recovery log storage unit, the difference log storage unit, and the DB depicted in FIG. 7. The CPU 45 reads recovery log file data 43a, difference log file data 43b, and database data 43c from the recovery log file data table 42a, the difference log file data table 42b, and the database data table 42c, and stores the data 43a, 43b, and 43c in the RAM 43. The HDD 42 performs various processes according to the recovery log file data 43a, the difference log file data 43b, and the database data 43c stored in the RAM 43.

The computer programs 44a, 44b, 44c, and 44d are not necessarily required to be stored in the ROM 44 in advance. The computer programs may be stored, for example, in a “portable physical media” such as a flexible disk (FD), a CD-ROM, a digital versatile disk (DVD), a magnetic optical disk, and an integrated circuit (IC) card, in a “fixed physical media” such as an HDD provided inside or outside of the computer 40, or in “another computer (or a server)” connected to the computer 40 via a public line, the Internet, a local area network (LAN), a wide area network (WAN), and the like. The computer 40 may read the computer programs therefrom and execute the computer programs.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A complete dual system comprising:
an operation node that executes an on-line operation in response to a request from a user;
a standby node that recovers the operation node when a trouble occurs in the operation node so that the on-line operation is restarted after the standby node is switched over to a new operation node;
a modification history storage unit in which history of modifications made to a database included in the old operation node before the on-line operation is restarted is stored;
a modification history correcting information storage unit in which modification history correcting information that is used to correct the history of the modifications stored in the modification history storage unit to be equivalent to a state when the on-line operation is restarted is stored;
a modification history correcting unit that corrects the history of the modifications stored in the modification history storage unit to be equivalent to the state when the on-line operation is restarted by using the modification history correcting information stored in the modification history correcting information storage unit; and
a database recovering unit that recovers the database included in the old operation node to be equivalent to the state when the on-line operation is restarted, based on the history of the modifications corrected by the modification history correcting unit.

2. The complete dual system according to claim 1, wherein the modification history correcting unit compares the history of the modifications stored in the modification history storage unit with the modification history correcting information stored in the modification history correcting information storage unit, and if the history of the modifications is newer, a newer part of the history of the modifications is nullified to correct the history of the modifications.

3. The complete dual system according to claim 1, wherein the modification history correcting unit compares the history of the modifications stored in the modification history storage unit with the modification history correcting information stored in the modification history correcting information storage unit, and if the modification history correcting information is newer, the history of the modifications is complemented with a newer part of the modification history correcting information to correct the modification history correcting information.

4. The complete dual system according to claim 1, further comprising a modification updating unit that updates a database included in a new standby node with modifications made to a database included in the new operation node before the system is reconstructed after the on-line operation is restarted, when the system is reconstructed by integrating, as the new standby node, the old operation node in which the database included is recovered by the database recovering unit.

5. A system control method in a complete dual system that includes an operation node that executes an on-line operation in response to a request from a user and a standby node that recovers the operation node when a trouble occurs in the operation node so that the on-line operation is restarted after the standby node is switched over to a new operation node, the system control method comprising:
storing, in a storage unit, history of modifications made to a database included in the old operation node before the on-line operation is restarted;
storing, in a storage unit, modification history correcting information used to correct the history of the modifications stored in the storage unit to be equivalent to a state when the on-line operation is restarted;
correcting the history of the modifications stored in the storage unit to be equivalent to the state when the on-line operation is restarted by using the modification history correcting information stored in the storage unit; and
recovering the database included in the old operation node to be equivalent to the state when the on-line operation is restarted, based on the corrected history of the modifications.

6. The system control method according to claim 5, wherein the correcting includes comparing the history of the modifications stored in the storage unit with the modification history correcting information stored in the storage unit, and if the history of the modifications is newer, nullifying a newer part of the history of the modifications to correct the history of the modifications.

7. The system control method according to claim 5, wherein the correcting includes comparing the history of the modifications stored in the storage unit with the modification history correcting information stored in the storage unit, and if the modification history correcting information is newer, complementing the history of the modifications with a newer part of the modification history correcting information to correct the history of the modifications.

8. The system control method according to claim 5, further comprising updating a database included in a new standby node with modifications made to a database included in the new operation node before the system is reconstructed after the on-line operation is restarted, when the system is reconstructed by integrating, as the new standby node, the old operation node in which the database included is recovered at the recovering.

9. A computer readable storage medium containing instructions for recovering an operation node that executes an on-line operation in response to a request from a user when a trouble occurs in the operation node so that an on-line operation is restarted after a standby node is switched over to a new operation node in a complete dual system, wherein the instructions, when executed by a computer, cause the computer to perform:
storing, in a storage unit, history of modifications made to a database included in the old operation node before the on-line operation is restarted;
storing, in a storage unit, modification history correcting information used to correct the history of the modifications stored in the storage unit to be equivalent to a state when the on-line operation is restarted;
correcting the history of the modifications stored in the storage unit to be equivalent to the state when the on-line operation is restarted by using the modification history correcting information stored in the storage unit; and
recovering the database included in the old operation node to be equivalent to the state when the on-line operation is restarted, based on the corrected history of the modifications.

10. The computer readable storage medium according to claim 9, wherein the correcting includes comparing the history of the modifications stored in the storage unit with the modification history correcting information stored in the storage unit, and if the history of the modifications is newer, nullifying a newer part of the history of the modifications to correct the history of the modifications.

11. The computer readable storage medium according to claim 9, wherein the correcting includes comparing the history of the modifications stored in the storage unit with the modification history correcting information stored in the storage unit, and if the modification history correcting information is newer, complementing the history of the modifications with a newer part of the modification history correcting information to correct the history of the modifications.

12. The computer readable storage medium according to claim 9, wherein the instructions further cause the computer to perform updating a database included in a new standby node with modifications made to a database included in the new operation node before the system is reconstructed after the on-line operation is restarted, when the system is reconstructed by integrating, as the new standby node, the old operation node in which the database included is recovered at the recovering.
